(19) United States
(12) Patent Application Publication
(10) Pub. No.: US 2026/0063817 A1
(43) Pub. Date: Mar. 5, 2026

(54) SIMPLENET-BASED METHOD FOR FIRST ARRIVAL PICKING IN SEISMIC DATA

(71) Applicant: Institute of Geomechanics,Chinese Academy of Geological Sciences., Beijing (CN)

(72) Inventors: Hao Zhang, Beijing (CN); Cheng Chen, Beijing (CN); Chongyuan Zhang, Beijing (CN); Dongsheng Sun, Beijing (CN); Yuanjian Zhou, Beijing (CN)

(21) Appl. No.: 19/317,109

(22) Filed: Sep. 2, 2025

(30) Foreign Application Priority Data
Sep. 3, 2024 (CN) 202411227157.8

(51) Int. Cl. G01V 1/32; G01V 1/30; G01V 1/34; G06V 10/764; G06V 10/77

(52) U.S. Cl. CPC G01V 1/32; G01V 1/303; G01V 1/345; G06V 10/764; G06V 10/7715; G01V 2210/41

(57) ABSTRACT

A SimpleNet-based method for first arrival picking in seismic data is provided, which relates to the field of seismic data processing technologies. The method includes: obtaining seismic shot gather data, and converting the seismic shot gather data into grayscale images to thereby obtain a functionally concentrated and enhanced grayscale image set; classifying the functionally concentrated and enhanced grayscale image set to obtain a training image set and a testing image set; performing low-velocity zone statics correction on the training image set to obtain a corrected training image set; constructing, based on the functionally concentrated and enhanced grayscale image set, a seismic first arrival prediction model; training, based on the corrected training image set, the seismic first arrival prediction model to obtain a seismic first arrival training model; optimizing parameters of the seismic first arrival training model to obtain an optimized seismic first arrival training model.

### CROSS-REFERENCE TO RELATED APPLICATION

This application claims priority to Chinese Patent Application No. 202411227157.8, filed on Sep. 3, 2024, which is herein incorporated by reference in its entirety.

### TECHNICAL FIELD

The disclosure relates to the field of seismic data processing technologies, and more particularly to a SimpleNet-based method for first arrival picking in seismic data.

### BACKGROUND

Static correction technology in shallow seismic exploration is used to eliminate an influence of terrain, and its core lies in dealing with an influence of low-velocity zones on deep seismic imaging. Undulation of the terrain and a thickness change of the low-velocity zones will prolong a propagation time of seismic waves, resulting in distortion of deep seismic imaging and even the generation of false structures. In order to reduce the interference of the low-velocity zones, commonly used static correction technologies include elevation static correction, first arrival wave static correction, refraction wave static correction, micro-logging, dune curve and tomographic refraction static correction. However, these technologies have the following limitations in practical applications. The elevation static correction does not take into account velocity and thickness changes of the low-velocity zones. The first arrival wave static correction is suitable for a case where the low-velocity zone is thin and uniform, but the effect is poor when the thickness changes greatly. Therefore, accuracy of first arrival picking of traditional static correction technologies is not high, which has become a key challenge in the development of static correction technologies.

### SUMMARY

Based on this, it is necessary for the disclosure to provide a SimpleNet-based method for first arrival picking in seismic data, to solve at least one of the above technical problems.

In order to achieve the above purpose, the disclosure provides a SimpleNet-based method for first arrival picking in seismic data, including the following steps:
step S1, obtaining, by geophones, seismic shot gather data, and converting the seismic shot gather data into grayscale images to thereby obtain a functionally concentrated and enhanced grayscale image set;
step S2, classifying the functionally concentrated and enhanced grayscale image set to obtain a training image set and a testing image set, and performing low-velocity zone static correction on the training image set to obtain a corrected training image set;
step S3, constructing, based on the functionally concentrated and enhanced grayscale image set, a seismic first arrival prediction model; training, based on the corrected training image set, the seismic first arrival prediction model to obtain a seismic first arrival training model; and optimizing parameters of the seismic first arrival training model to obtain an optimized seismic first arrival training model; and
step S4, performing, by using the optimized seismic first arrival training model, seismic first arrival prediction on the testing image set to obtain seismic first arrival prediction data; classifying, based on image sizes, the seismic first arrival prediction data to obtain fixed-size image prediction data and arbitrary-size image prediction data; and evaluating prediction results of the fixed-size image prediction data and the arbitrary-size image prediction data to obtain prediction result evaluation data, and uploading the prediction result evaluation data to a seismic shot platform processing system to execute a seismic first arrival prediction task.

In an exemplary embodiment, the SimpleNet-based method for first arrival picking in seismic data further includes:
uploading the seismic first arrival prediction data to a seismic early warning system, and issuing, by the seismic early warning system, a warning signal to relevant personnels according to the seismic first arrival prediction data; where the seismic first arrival prediction data includes a seismic first arrival time.

The disclosure converts the seismic shot gather data into the grayscale images, which helps to simplify data processing, and reduce data complexity, while retaining main features of seismic waves. Through functionally concentrating and enhancing, contrasts and details of the images are enhanced, thereby improving quality of the images, so that subsequent image analysis and model training are more accurate. The enhanced grayscale images make seismic signals more significant, which helps to extract more accurate features. The grayscale images reduce a dimension of the data and simplifies the subsequent processing steps, such as feature extraction and model training. The functionally concentrated and enhanced grayscale image set is classified into the training image set and the testing image set, which ensures that the training and evaluation of the model (i.e., the seismic first arrival prediction model) are based on independent dataset, thereby improving a generalization ability of the model. The classification of the training image set and the testing image set ensures performance evaluation of the model on unseen data, thereby improving reliability of the model. The training image set is subjected to low-velocity zone statics correction to obtain the corrected image set, and the corrected image set can reduce errors caused by velocity change, so that the seismic first arrival prediction model can more accurately recognize first arrival times of the seismic waves. The low-velocity zone statics correction reduces the errors caused by velocity change, and improves a prediction accuracy of the first arrival times of the seismic waves. The seismic first arrival prediction model is constructed based on the enhanced grayscale image set, and the model is used to predict the first arrival times of the seismic waves. The model is trained by using the corrected training image set to optimize the performance of the model on actual data. Through training and optimization, the model can more accurately recognize the first arrival times of the seismic waves, thereby improving the prediction accuracy. The parameters of the trained model (i.e., the seismic first arrival training model) are optimized and adjusted to improve the prediction accuracy. The optimized model (i.e., the optimized seismic first arrival training model) can better adapt to different seismic data sets and improve the generalization ability of the model. The optimized model is used to predict the seismic first arrival times of the testing image set data. The optimized model can accurately predict the seismic first arrival times, and improve an efficiency of actual seismic detection. The prediction results (i.e., the seismic first arrival prediction data) are classified by the image sizes into two categories, including the fixed-size image prediction data and the arbitrary-size image prediction data, so as to analyze the prediction effect in more detail. The prediction results are evaluated, and the performance of the model on images of different sizes is analyzed to ensure the accuracy and reliability of the prediction results. By classifying and evaluating the prediction results of images of different sizes, advantages and disadvantages of the model can be found, and the model can be further optimized. The evaluation data is uploaded to the seismic slot platform for further processing and application.

In an embodiment, the step S1 specifically includes:
step S11, obtaining the seismic shot gather data, and performing data-to-image mapping on the seismic shot gather data to obtain seismic shot gather grayscale images;
step S12, performing first arrival function salient labeling on the seismic shot gather grayscale images to obtain salient grayscale images;
step S13, performing first arrival function distribution label cropping on the salient grayscale images to obtain concentrated grayscale images; and
step S14, performing data enhancement on the concentrated grayscale images to obtain the functionally concentrated and enhanced grayscale image set.

The disclosure collects original seismic wave data (i.e., the seismic shot gather data) from seismic slot equipment, and converts the original seismic wave data into visualized grayscale images. The data-to-image mapping generally includes converting parameters such as velocity and amplitude into grayscale values through a suitable algorithm. The grayscale value of each pixel reflects physical characteristics of underground structures. The complex seismic data is converted into grayscale images, which are convenient for intuitive analysis and understanding of the underground structures, and provides a clear basis for the subsequent processing steps, so that signal processing and analysis are more efficient. By recognizing the first arrival wave information in the images, the images are subjected to salient labeling to emphasize the most important region for analysis, form the salient grayscale images, thereby highlighting the first arrival wave positions, which facilitates the analysis of propagation paths of the seismic waves and the characteristics of the underground structures. By salient labeling, an interference of non-critical regions is reduced, which is conducive for the accuracy of subsequent processing steps.

Unnecessary parts of the salient grayscale images are cropped, the first arrival wave information related to the underground structures is focused, the concentrated grayscale images are obtained, and redundant information is removed, so that the subsequent analysis is concentrated and simplified, the amount of calculation is reduced, and the analysis of specific regions is concentrated, which can extract key geological information more accurately. By using multiple data enhancement technologies (such as rotation, scaling and adding noise) to process the concentrated grayscale images, a training effect and a robustness of the subsequent algorithms can be improved. The enhanced image samples are diversified, which can improve an adaptability of the deep learning model to new data. By enhancing the data, the performance of the model in different scenarios will be more stable, thereby improving the accuracy of seismic wave detection and underground imaging.

In an embodiment, the step S14 specifically includes:
step S141, extracting grayscale image samples from the concentrated grayscale images to obtain concentrated grayscale image sample data;
step S142, performing a horizontal mirror transformation on the concentrated grayscale image sample data to obtain concentrated grayscale mirror data;
step S143, replacing image data in the concentrated grayscale images with the concentrated grayscale mirror data to obtain concentrated grayscale image replacement data; and
step S144, performing image enhancement integration on the concentrated grayscale image replacement data and the concentrated grayscale images to obtain the functionally concentrated and enhanced grayscale image set.

The disclosure extracts multiple sample data from the concentrated grayscale images. These samples can be sub-regions and regions selected in a specific way of the images (i.e., the concentrated grayscale images). Sample extraction enables image data of different regions to be analyzed and processed separately, thereby increasing the diversity of the dataset. The extracted sample data can be analyzed in a targeted manner, which helps to recognize and process specific features or problems in the concentrated grayscale images. The extracted grayscale image samples are horizontally mirrored, that is, the concentrated grayscale images are horizontally flipped. The horizontal mirror transformation increases the diversity of image samples and helps to train a more robust machine learning model. For image features with strong symmetry (such as underground structures), the mirror transformation can help the model better learn and recognize these features. The generated concentrated grayscale mirror data is used to replace part of the data in the original concentrated grayscale images to form new image data. The replacement operation can enhance an expression of certain specific features in the concentrated grayscale images, thereby improving a sensitivity of the model to these features. Through the replacement operation, the noise or defects in the image data can be improved, making the final image data clearer and more accurate. The concentrated grayscale image replacement data and the original concentrated grayscale images are integrated, and multiple image enhancement technologies (such as contrast adjustment and noise removal) are used to obtain the final concentrated grayscale enhanced images (i.e., the functionally concentrated and enhanced grayscale image set). The image quality is improved through integration and enhancement processing, making the details of the images clearer and facilitating further analysis. By integrating image data from different sources, the richness and representativeness of the data can be increased, and the effect of model training and analysis can be improved.

In an embodiment, the step S2 specifically includes:
step S21, classifying the functionally concentrated and enhanced grayscale image set to obtain the training image set and the testing image set;
step S22, plotting velocity profile distribution maps according to the training image set;
step S23, performing velocity statistics on the velocity profile distribution maps to obtain low-velocity data;
step S24, performing, based on the low-velocity data, regional positioning on the velocity profile distribution maps to obtain low-velocity regional data;
step S25, constructing, based on the low-velocity regional data, a low-velocity recognition model;
step S26, performing, based on the low-velocity recognition model, low-velocity recognition on the training image set to obtain a low-velocity training image set; and
step S27, performing, based on the low-velocity training image set, low-velocity correction on the training image set to obtain the corrected training image set.

The disclosure classifies the functionally concentrated and enhanced grayscale image set into the training image set and the testing image set. The training image set is usually used for model training, and the testing image set is usually used for model evaluation. By clearly classifying the training image set and the testing image set, the performance of the model on unseen data can be effectively evaluated to avoid overfitting. Through cross-validation or independent testing image set, the evaluation of model performance is more reliable, and the adjustment and optimization of the model can be effectively guided. The data in the training image set is used to plot the velocity profile distribution maps to show the change of wave velocities at different depths or lateral positions. Through the velocity profile distribution maps, a spatial distribution characteristic of the wave velocities can be intuitively identified, which helps to understand the underground hierarchical structure. The velocity profile distribution maps provide basic information for subsequent low-velocity data statistics and regional positioning. Based on the velocity profile distribution maps, the wave velocities are statistically analyzed to extract relevant data of the low-velocity zones. The low-velocity zone is a layer of the Earth's upper mantle that exhibits lower seismic velocities than the surrounding rocks. The low-velocity zone is located beneath the Earth's crust and extends from a depth of about 100 kilometers (km) to 250 km below the surface. The range of the low-velocity zone can vary from region to region, but it is generally around 150 km thick. The seismic velocity in general rock is more than 2000 meters per second (m/s) to 5000 m/s, while a seismic velocity in the low-velocity zone is 1500 m/s to 1700 m/s, which is much lower than the seismic velocity of the rock. The statistical analysis helps to reveal low-velocity characteristics in an entire profile, thereby providing a quantitative basis for subsequent positioning. Through the low-velocity data, a data foundation is laid for the construction of the low-velocity recognition model. Based on the low-velocity data, the low-velocity zones in the velocity profile are located, so as to extract the relevant regional data. The accurate regional positioning can clearly define the low-velocity zones and provide targeted regional data for subsequent model training and correction. The clear positioning of the low-velocity zones can provide valuable decision-making basis for geological exploration and related resource development. The obtained low-velocity regional data is used to construct the special low-velocity recognition model. By constructing the targeted model, the low-velocity characteristics can be better captured, the recognition efficiency and accuracy can be improved, and useful information can be extracted from complex data to support the subsequent analysis. The low-velocity recognition model is used to analyze the training image set to recognize the low-velocity image parts, and realize the automatic recognition of low-velocity, which greatly improves the work efficiency and reduces the need for manual intervention. The recognized low-velocity training images are helpful to optimize the subsequent image analysis and processing.

Based on the recognized low-velocity training image set, the original training image set is corrected to eliminate a negative impact of the low-velocity. The low-velocity correction can effectively improve the quality and accuracy of the training image set, lay a solid foundation for subsequent data analysis, and the corrected dataset (i.e., the corrected training image set) can better reflect actual wave velocity conditions and improve the performance of the model in practical applications.

In an embodiment, the step S25 specifically includes:
step S251, performing regional shape feature extraction, gradient feature extraction and change feature extraction on the low-velocity regional data to obtain regional shape data, gradient data and change data;
step S252, calculating geometric boundary smoothness for the regional shape data to obtain geometric boundary smoothness data;
step S253, performing gradient synthesis on the gradient data and the change data to obtain gradient synthesis data;
step S254, integrating the geometric boundary smoothness data and the gradient synthesis data to obtain geometric gradient data; and
step S255, constructing, based on the geometric gradient data, the low-velocity recognition model.

The disclosure can accurately describe a contour and structural characteristics of each low-velocity zone by analyzing the geometric shape of the low-velocity zone, which helps to recognize the boundaries, shapes and sizes of the low-velocity zones, and provide basic data for subsequent analysis. By calculating the gradient information in the low-velocity zones, the rates and directions of the wave velocity change in the low-velocity zones can be understood, which helps to recognize the region where the wave velocity changes, as well as abnormal conditions that exist. The dynamic characteristics of the region are recognized by focusing on capturing the changing trends and patterns of the wave velocity in the region. These changing characteristics can reveal evolution processes and potential problems of the low-velocity zones. By calculating the geometric boundary smoothness, a smoothness of the boundary of each low-velocity zone can be evaluated, which helps to remove noise and irregularities, making the regional boundary more accurate. The smoothness information of the boundary helps to better understand the geometric characteristics of the low-velocity zone, and ensure the accuracy and consistency of the data in subsequent processing. The gradient synthesis can generate comprehensive gradient information by combining multiple gradient data, which helps to obtain a more comprehensive velocity change situation, and improve the recognition accuracy of the low-velocity zones. The synthesized gradient data can more clearly display a velocity gradient distribution in the low-velocity zones, which helps to distinguish the low-velocity zones from the normal zones. The geometric boundary smoothness data is integrated with the gradient synthesis data, so that comprehensive geometric gradient data can be generated. This integration process helps to more accurately describe the overall characteristics and gradient distribution of the low-velocity zones. The geometric gradient data provides detailed characteristics of the low-velocity zones, which helps to better understand an internal structure and a velocity change pattern of the low-velocity zones. The low-velocity recognition model is constructed based on the geometric gradient data, so that the data extracted in the previous steps can be transformed into a model that can be used for practical applications.

The model can be used to automatically recognize and classify the low-velocity zones. The construction of the low-velocity recognition model can improve the automation and accuracy of regional recognition, reduce human intervention, and improve processing efficiency. Through the application of the model, large-scale data can be analyzed and processed more quickly to support decision-making and the formulation of action plans.

In an embodiment, the step S252 specifically includes:
extracting boundary point coordinate data from the regional shape data;
performing curve parameterization on the boundary point coordinate data to obtain curve parameterized data;
calculating, based on the curve parameterized data, curvatures of boundary points to obtain boundary point curvature data;
calculating an average curvature of the boundary point curvature data to obtain average curvature data; and
calculating, based on the average curvature data, a smoothness index to obtain the geometric boundary smoothness data.

The disclosure can clearly define the shape features of the low-velocity zones through the extraction of the boundary points, laying a foundation for subsequent analysis, and can be used for tasks such as object recognition and image segmentation, so that the algorithm can process the target object more accurately, which helps to simplify data, reduce the amount of information to be processed in subsequent steps, and improve calculation efficiency. Through parameterization, irregular boundary points can be converted into mathematical curve forms, which is convenient for more complex mathematical analysis. The curves are parameterized to provide a standardized representation method, which is convenient for subsequent calculations, including mapping, interpolation, deformation and the like, which is conducive to realizing the scaling, rotation and transformation of the curves and improving the flexibility of the graphics. Curvature is an important indicator for describing the change of boundary shape, and providing information about the geometric characteristics of the curve path. The calculation of curvature can help recognize the characteristic regions of the boundary, such as corners, and flat sections, which is crucial for shape analysis. Through curvature data, it can assist in the classification and feature extraction of the boundary points, and provide support for subsequent algorithms (such as edge detection and shape matching). By calculating the average curvatures, the overall smoothness and variation of the shape can be obtained, which plays a key role in shape feature analysis. This indicator (i.e., the average curvature) can provide a basis for optimization algorithms (such as path planning and shape compression), improve the rationality and reliability of the results, and help compare between multiple shapes, so that researchers can analyze the geometric characteristics of different regions. The smoothness index provides a quantitative assessment of the smoothness of the shape boundary, which can help to determine and screen the quality of the boundary, help to reduce noise in numerical calculations, and improve the accuracy and stability of subsequent processing (such as graphics reconstruction and shape matching).

In an embodiment, the step S253 specifically includes:
calculating a gradient amplitude for the gradient data to obtain gradient amplitude data;
calculating change rates of the change data to obtain change rate data;
performing spatial alignment on the gradient amplitude data and the change rate data to obtain change spatial alignment data; and
performing weight synthesis on the change spatial alignment data and the gradient amplitude data to obtain the gradient synthesis data.

The disclosure can obtain the intensity information of the changes in the data by calculating the gradient amplitudes, which helps to recognize edges and features in the images or signals, making further analysis more accurate. The change rates of change data are calculated, and a speed and a degree of data change can be measured, which is particularly important for a trend analysis of dynamic systems or time series data. The change rate data is spatially aligned with the gradient amplitude data, which can ensure the consistency of data from different data sources or different time points in space, thereby improving the accuracy and reliability of the analysis. By performing the weight synthesis on the change spatial alignment data and the gradient amplitude data, more sophisticated and comprehensive gradient synthesis data can be generated in combination with the intensity and spatial information of the changes, which helps further analysis and processing, such as image enhancement or signal optimization.

In an embodiment, the step S3 specifically includes:
step S31, constructing the seismic first arrival prediction model based on the functionally concentrated and enhanced grayscale image set;
step S32, extracting seismic first arrival time data and seismic first arrival location data from the corrected training image set;
step S33, calculating, based on the seismic first arrival time data, a first arrival time probability to obtain seismic first arrival time probability data;
step S34, performing first arrival extent statistics on the seismic first arrival location data to obtain seismic first arrival extent data;
step S35, integrating the seismic first arrival time probability data and the seismic first arrival extent data to obtain seismic first arrival data;
step S36, training, based on the seismic first arrival data, the seismic first arrival prediction model to obtain the seismic first arrival training model; and
step S37, optimizing, based on the corrected training image set, the parameters of the seismic first arrival training model to obtain the optimized seismic first arrival training model.

The disclosure constructs the seismic first arrival prediction model by the functionally concentrated and enhanced grayscale image set, which helps to improve the recognition ability of the model for seismic signals in the images, thereby improving the prediction accuracy. Extracting the seismic first arrival time and position data provides basic data for subsequent analysis, ensuring that the training and correction of the prediction model have a reliable source of information. Calculating the first arrival time probability data helps to understand a possibility of earthquakes at different time points and enhances an ability to predict the occurrence time of earthquakes. Statistics of the first arrival extent data helps determine a spatial extent of the seismic signals and provides data support for accurately predicting the occurrence locations of earthquakes. Integrating the first arrival time probability data and the first arrival extent data can comprehensively consider the temporal and spatial characteristics of occurrence of earthquakes, and improve the accuracy of the overall prediction model. The prediction model is trained by the seismic first arrival data, so that the model is better adapted to actual data, thereby improving the prediction performance. Model parameter optimization further improves the accuracy and stability of the model, making the final seismic first arrival prediction model more reliable in practical applications.

In an embodiment, the step S4 includes:
step S41, performing, based on the optimized seismic first arrival training model, the seismic first arrival prediction on the testing image set to obtain the seismic first arrival prediction data;
step S42, classifying, based on the image sizes, the seismic first arrival prediction data to obtain the fixed-size image prediction data and the arbitrary-size image prediction data;
step S43, calculating, based on the corrected training image set, a fixed-size image prediction accuracy of the fixed-size image prediction data to obtain fixed-size image prediction accuracy data;
step S44, calculating, based on the corrected training image set, an arbitrary-size image prediction accuracy of the arbitrary-size image prediction data to obtain arbitrary-size image prediction accuracy data;
step S45, integrating the fixed-size image prediction accuracy data and the arbitrary-size image prediction accuracy data to obtain seismic first arrival prediction accuracy data; and
step S46, evaluating a prediction result of the seismic first arrival prediction accuracy data to obtain the prediction result evaluation data, and uploading the prediction result evaluation data to the seismic shot platform processing system to execute the seismic first arrival prediction task.

The disclosure can obtain the seismic first arrival prediction data by predicting the testing image set based on the optimized seismic first arrival training model. The key effect of this step is to use the optimized model to accurately predict the new data, and provide preliminary seismic occurrence time and location prediction for actual seismic early warning. The seismic first arrival prediction data is classified by the image sizes into two categories, including the fixed-size image prediction data and the arbitrary-size image prediction data. This classification can help to process different types of image data separately, so that the prediction results can obtain corresponding accuracy analysis under different conditions. Based on the corrected training image set, the accuracy of the fixed-size image prediction data is calculated, and the prediction accuracy of the model on the fixed-size image can be evaluated. The beneficial effect of this step is that the performance of the model under standardized image conditions can be revealed, providing a reference for further optimization. Based on the corrected training image set, the accuracy of the arbitrary-size image prediction data is calculated, and the prediction performance of the model when processing images of different sizes can be evaluated. The beneficial effect of this step is that it can ensure that the model has good prediction ability when processing multiple image sizes encountered in actual applications. The prediction accuracy data of fixed-size and arbitrary-size are integrated to obtain comprehensive seismic first arrival prediction accuracy data. The integrated data can provide a comprehensive model performance evaluation, reflecting the overall accuracy of the model under different conditions. The results of the seismic first arrival prediction accuracy data are evaluated to obtain the evaluation data, and the evaluation data is uploaded to the seismic shot platform processing system. The beneficial effect of this step is to use the evaluation results in practical applications to ensure that the prediction results can effectively provide decision support for the seismic early warning system and enhance the timeliness and accuracy of seismic prediction.

In an embodiment, the step S43 includes:
step S431, extracting fixed-size seismic first arrival prediction data from the fixed-size image prediction data;
step S432, extracting seismic first arrival corrected data from the corrected raining image set;
step S433, performing, based on the seismic first arrival corrected data, seismic first arrival annotation comparison on the fixed-size seismic first arrival prediction data to obtain fixed-size image seismic first arrival annotation comparison data; and
step S434, performing, based on the corrected training image set, accuracy calculation on the fixed-size image seismic first arrival annotation comparison data to obtain the fixed-size image prediction accuracy data.

The disclosure extracts the seismic first arrival prediction data through fixed-size images, which can ensure consistency in different regions or image sizes, help to reduce the prediction errors caused by image size differences, and improve data comparability and processing efficiency. Extracting the seismic first arrival corrected data helps to construct an accurate corrected model. This step provides real reference data for subsequent verification and optimization of prediction data, and enhances the reliability of the model. Preforming the seismic first arrival annotation comparison can reveal the differences between the predicted data and the actual annotations. This comparative analysis helps to recognize the prediction errors and potential problems of the model, and provides a direction for further improving the model. By calculating the prediction accuracy, the performance of the prediction model can be quantified and its accuracy can be evaluated. This provides clear indicators for optimizing the prediction model and improves the credibility of the final prediction results.

### BRIEF DESCRIPTION OF DRAWINGS

Other features, objects and advantages of the disclosure will become more apparent from a detailed description of non-limiting embodiments thereof made with reference to the following drawings.

FIG. 1 illustrates a flowchart of a SimpleNet-based method for first arrival picking in seismic data according to the disclosure.

FIG. 2 illustrates a flowchart of step S1 of the SimpleNet-based method for first arrival picking in seismic data according to the disclosure.

FIG. 3 illustrates a flowchart of step S14 of the SimpleNet-based method for first arrival picking in seismic data according to the disclosure.

FIG. 4 illustrates a schematic diagram of a comparison result of first arrival picking between a traditional method and the SimpleNet-based method for first arrival picking in seismic data according to the disclosure.

FIG. 5 illustrates a schematic diagram of a picking error comparison between the traditional method and the SimpleNet-based method for first arrival picking in seismic data according to the disclosure.

FIG. 6 illustrates a schematic diagram of a zoomed-in comparison between the traditional method and the SimpleNet-based method for first arrival picking in seismic data according to the disclosure.

The realization of the objectives, functional features and the advantages of the disclosure will be further described in conjunction with embodiments and with reference to the drawings.

### DETAILED DESCRIPTION OF EMBODIMENTS

A technical method of the disclosure is clearly and completely described below in conjunction with the drawings. Apparently, the described embodiments are some of embodiments of the disclosure, not all of the embodiments. Based on the embodiments of the disclosure, all other embodiments obtained by those skilled in the art without creative work are within a scope of protection of the disclosure.

In addition, the drawings are only schematic illustrations of the disclosure and are not necessarily drawn to scale. Same reference numerals in the drawings represent the same or similar parts, and their repeated description will be omitted. Some of block diagrams shown in the drawings are functional entities and do not necessarily correspond to physically or logically independent entities. The functional entities can be implemented in software form, or implemented in one or more hardware modules or integrated circuits, or implemented in different networks and/or processor methods and/or microcontroller methods.

It should be understood that, although terms “first”, “second”, and the like may be used herein to describe each unit, these units should not be limited by these terms. These terms are used only to distinguish one unit from another unit. For example, without departing from a scope of the exemplary embodiments, the first unit may be referred to as the second unit, and similarly the second unit may be referred to as the first unit. The term “and/or” used herein includes any and all combinations of one or more of the listed associated items.

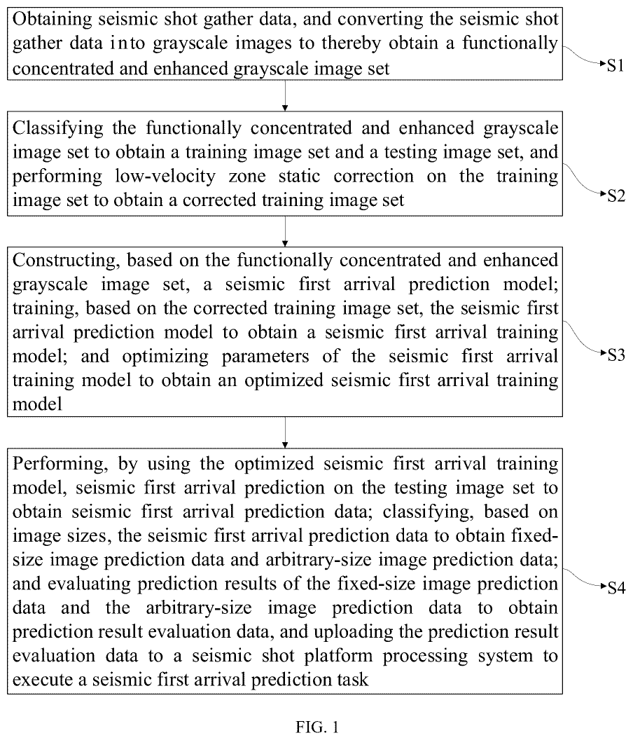

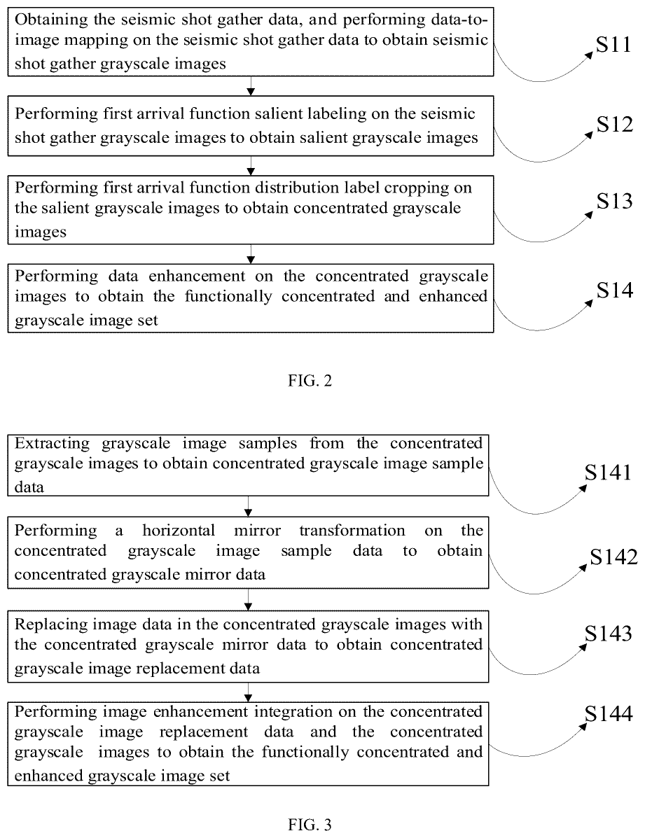

In order to achieve the above objectives, referring to FIG. 1 to FIG. 3, the disclosure provides a SimpleNet-based method for first arrival picking in seismic data, and the method includes the following steps S1-S4.

In step S1, seismic shot gather data is obtained, and the seismic shot gather data is converted into grayscale images to thereby obtain a functionally concentrated and enhanced grayscale image set.

In the embodiment, the seismic shot gather data is collected. The seismic shot gather data includes original seismic signals obtained from a seismic detection instrument. The original seismic signals are usually recorded as an image form (for example, acoustic reflection images of seismic waves). These image data is converted into grayscale images before processing theses image data, which can be achieved by converting color channels of red-green-blue (RGB) images into a single brightness channel. This process helps to reduce complexity of the images, and focus on intensity information of the seismic waves. Then, an image enhancement technology is used to improve a contrast and clarity of each image. The image enhancement technology includes a histogram equalization method, a contrast limited adaptive histogram equalization (CLAHE) method and the like. These technologies can make characteristics of the seismic waves more significant, thereby improving accuracy of the subsequent processing and analysis. Finally, a group of enhanced grayscale image set is obtained, preparing for a next step of data set classification.

In step S2, the functionally concentrated and enhanced grayscale image set is classified to obtain a training image set and a testing image set. The training image set is subjected to low-velocity zone statics correction to obtain a corrected training image set.

In the embodiment, these image data is classified into the training image set and the testing image set based on the functionally concentrated and enhanced grayscale image set. A common classification ratio is 80% for training and 20% for testing. Representativeness and balance of the data during classification are ensured, so that various seismic features can be covered when training the model. The training image set is subjected to low-velocity zone static correction, which usually includes correcting the seismic waves in the images to eliminate influence of the low-velocity zones (such as crustal inhomogeneities) on wave propagation. Existing correction algorithms can be used, for example, a correction technology based on velocity model. The corrected image set is called a corrected training image set, which ensures that the images used for training have more accurate seismic features, thereby improving a prediction ability of the model.

In step S3, a seismic first arrival prediction model is constructed based on the functionally concentrated and enhanced grayscale image set. The seismic first arrival prediction model is trained based on the corrected training image set to obtain a seismic first arrival training model. Parameters of the seismic first arrival training model are optimized to obtain an optimized seismic first arrival training model.

In the embodiment, the seismic first arrival prediction model is constructed based on the functionally concentrated and enhanced grayscale image set. This can be achieved by selecting an appropriate machine learning algorithm, such as a convolutional neural network (CNN), and designing an appropriate network architecture (such as a combination of a convolutional layer, a pooling layer, and a fully connected layer). A goal of the model is to predict first arrival times of the seismic waves from the input images, that is, the first arrival times are times when the seismic waves arrives at a detection point from a source. The initially constructed prediction model is trained by using the corrected training image set. This includes training the model for multiple rounds (epochs) and adjusting weights and biases of the model to minimize prediction errors. A cross-validation technology is used during training to ensure that the model performs consistently on different data subsets. After model training, parameter optimization is required. A hyperparameter tuning technology, such as grid search or Bayesian optimization, can be used to adjust hyperparameters such as learning rate and batch size to obtain optimal model performance.

The optimized model is called the optimized seismic first arrival training model.

In step S4, seismic first arrival prediction is performed on the testing image set by using the optimized seismic first arrival training model to obtain seismic first arrival prediction data. The seismic first arrival prediction data is classified based on image sizes to obtain fixed-size image prediction data (i.e., prediction data of images in a fixed size) and arbitrary-size image prediction data (i.e., prediction data of images in a size not fixed). Prediction results of the fixed-size image prediction data and the arbitrary-size image prediction data are evaluated to obtain prediction result evaluation data, and the prediction result evaluation data is uploaded to a seismic shot platform processing system to execute a seismic first arrival prediction task.

In the embodiment, the seismic first arrival prediction is performed on the testing image set by using the optimized seismic first arrival training model. The testing image set is predicted to obtain seismic first arrival time data of each image. The prediction results are classified based on the image sizes. Assuming that the images have two sizes, including fixed-and arbitrary-size. The fixed-size image prediction data and the arbitrary-size image prediction data are evaluated respectively, and indexes, such as prediction accuracy, recall rate and F1-score, are used to measure quality of the prediction results. Finally, the prediction results are uploaded to the seismic shot platform processing system. The seismic shot platform processing system can be used to further data analysis and visualization to help seismic researchers to understand characteristics of seismic wave propagation and make decisions. The upload process includes storing the prediction results and evaluation data in a standard format and ensuring integrity and accuracy of the data.

In an embodiment, the SimpleNet network includes a feature extractor, an adapter, an abnormal feature generator, and a discriminator, which achieve accurate data analysis and prediction through automatic learning and optimization of weight structures.

In an embodiment, the step S1 specifically includes the following steps S11 to S14.

In step S11, the seismic shot gather data is obtained, and data-to-image mapping is performed on the seismic shot gather data to obtain seismic shot gather grayscale images.

In the embodiment, the obtaining the seismic shot gather data includes collecting original seismic wave data from the seismic detection instrument. These data are usually in a form of continuous time series, including amplitude information of the seismic waves. The data-to-image mapping process converts the time series data into an image format, and a common technique is to map an amplitude value of the seismic wave to a pixel value of the grayscale image. For example, a normalization technique can be used to map the amplitude value to the pixel value in a range of 0-255 to generate a corresponding grayscale image. An intensity of the seismic wave is represented as different grayscale levels in the image.

In step S12, first arrival function salient labeling is performed on the seismic shot gather grayscale image to obtain salient grayscale images.

In the embodiment, the first arrival function salient labeling is to recognize characteristics of the first arrival waves by processing the grayscale images. An image process algorithm, such as edge detection (for example, Canny edge detection) or a threshold segmentation method, is used to saliently label the characteristics of the first arrival waves in the images. For example, an adaptive threshold method is applied, which can highlight an obvious region of the first arrival waves, and generate the salient grayscale images to clearly label positions and an intensity of the first arrival waves.

In step S13, first arrival function distribution label cropping is performed on the salient grayscale images to obtain concentrated grayscale images.

In the embodiment, the first arrival function distribution label cropping is performed on the salient grayscale images, with a goal of removing unnecessary background noise and irrelevant image parts. This process usually includes using an image cropping algorithm to crop the images based on a spatial distribution of the first arrival waves. For example, by setting a region of interest (ROI), only the obvious region of the first arrival waves is retained to generate the concentrated grayscale images, which can effectively focus on a main feature region.

In step S14, data enhancement is performed on the concentrated grayscale images to obtain the functionally concentrated and enhanced grayscale image set.

In the embodiment, the data enhancement of the concentrated grayscale images is used to improve quality of the images and robustness of the model. Common data enhancement technologies include rotation, translation, scaling, and color jittering. For example, rotation and scaling transformations are performed on the concentrated grayscale images to generate multiple enhanced images, thereby simulating different observation angles and conditions to enhance the generalization ability of the model and the ability to recognize seismic wave characteristics.

In an embodiment, the step S14 specifically includes the following steps S141 to S144.

In step S141, grayscale image samples are extracted from the concentrated grayscale images to obtain concentrated grayscale image sample data.

In the embodiment, in image processing, the grayscale image samples are extracted from the concentrated grayscale images, generally involving the following steps. Firstly, sampling window sizes and positions are defined to extract pixel values of a specific region from the original grayscale images as sample data. This can be achieved by extracting by sliding window or region selection. For example, in face recognition, sample data is formed by extracting feature regions such as eyes and mouth, and then feature learning and recognition are performed.

In step S142, a horizontal mirror transformation is performed on the concentrated grayscale image sample data to obtain concentrated grayscale mirror data.

In the embodiment, the horizontal mirror transformation of the concentrated grayscale image sample data is a common data enhancement technology that can be used to expand the training data set to enhance the generalization ability of the model. This involves flipping the original images along a vertical central axis to generate mirror data. For example, for traffic sign recognition, a left-right structure of an original sign can be transformed through the horizontal mirror transformation to increase the diversity of training data.

In step S143, image data of the concentrated grayscale images is replaced with the concentrated grayscale mirror data to obtain concentrated grayscale image replacement data.

In the embodiment, in the image data replacement stage, the concentrated grayscale image is replaced or fused at pixel level with the concentrated grayscale mirror data. This can include pixel-level difference calculation, application of a blending mode, or pixel replacement based on conditional determination. For example, in image restoration, the content filling operation uses a replacement technique to fill in the missing region, so that it is coordinated with the surrounding environment.

In step S144, image enhancement integration is performed on the concentrated grayscale image replacement data and the concentrated grayscale images to obtain the functionally concentrated and enhanced grayscale image set.

In the embodiment, the image enhancement integration involves the integration of various enhancement processing methods through the concentrated grayscale image replacement data and the original grayscale images. This includes operations such as histogram equalization, filtering, and sharpening. For example, in medical image processing, the contrast and clarity of the image can be improved by fusing the mirror data and using the enhancement technology, thereby better showing details of the lesion or tissue structure.

In an embodiment, the step S2 specifically includes the following steps S21 to S227.

In step S21, the functionally concentrated and enhanced grayscale image set is classified to obtain the training image set and the testing image set.

In the embodiment, images in the functionally concentrated and enhanced grayscale image set represent different scenes or objects. The images are pretreated, such as standardization and denoising. Then, the image set is randomly classified into the training image set and the testing image set based on a certain ratio (such as 80%: 20%). The training image set is used for model training, and the testing image set is used for evaluating the model performance. In a specific implementation, the data enhancement technologies (such as rotation, translation, and scaling) can be used to expand the training image set to improve the generalization ability of the model.

In step S22, velocity profile distribution maps are plotted according to the training image set.

In the embodiment, for each image in the training image set, a velocity profile distribution map is generated by using an appropriate algorithm (such as gradient boosting, and convolutional neural network). The map depicts wave velocity changes in different regions of the images. The generation process includes image feature extraction and wave velocity calculation, and this wave velocity information can be obtained through a set calculation model. In the specific implementation, different wave velocity calculation methods, such as Fourier transform, can be selected to generate profiles of different forms.

In step S23, velocity statistics is performed on the velocity profile distribution maps to obtain low-velocity data.

In the embodiment, the statistics analysis is performed on the velocity profile distribution maps to obtain wave velocity data. Low-velocity values are recognized through statistics methods (such as mean, median, and standard deviation). Specifically, the threshold segmentation method or the histogram analysis method can be used to distinguish the low-velocity zones. During implementation, appropriate threshold standards are set to ensure the accuracy of the low-velocity data, and post-processing (such as filtering) is required to remove noise.

In step S24, regional positioning is performed on the velocity profile distribution maps based on the low-velocity data to obtain low-velocity regional data.

In the embodiment, the regional positioning is performed on the velocity profile distribution maps based on the low-velocity data to label the low-velocity zones. This process includes using a region growing algorithm or the threshold segmentation method to define the low-velocity zones. During implementation, the image segmentation method such as K-means clustering can be combined to accurately position these zones and generate labeled maps of the low-velocity zone data.

In step S25, a low-velocity recognition model is constructed based on the low-velocity regional data.

In the embodiment, the low-velocity recognition model is constructed based on the low-velocity regional data. A suitable machine learning model (such as a support vector machine, and a deep neural network) is selected and trained to recognize and classify low-velocity zones in the images. In the specific implementation, it is necessary to design a training process, including model selection, hyperparameter tuning, and cross-validation, to ensure the accuracy and robustness of the model.

In step S26, low-velocity recognition is performed on the training image set based on the low-velocity recognition model to obtain a low-velocity training image set.

In the embodiment, the constructed low-velocity recognition model is used to perform low-velocity recognition on the training image set to generate the low-velocity training image set. This step involves model prediction and post-processing to determine which image regions are classified as the low-velocity zones. During implementation, it is necessary to evaluate the recognition accuracy of the model and perform multiple iterations to optimize the results.

In step S27, low-velocity correction is performed on the training image set based on the low-velocity training image set to obtain the corrected training image set.

In the embodiment, the low-velocity zones in the training image set are corrected to generate the corrected training image set. This step uses the output results of the low-velocity recognition model to adjust the images to correct errors or deviations in the recognition. In specific implementation, it is necessary to apply the image processing technology (such as image fusion and enhancement) to improve the image quality and ensure that the corrected image set can more accurately reflect the low-velocity characteristics.

In an embodiment, the step S25 specifically includes the following steps S251 to S255.

In step S251, regional shape feature extraction, gradient feature extraction and change feature extraction are performed on the low-velocity regional data to obtain regional shape data, gradient data and change data.

In the embodiment, the low-velocity regional data is processed to extract multiple features. Firstly, the regional shape feature extraction involves recognizing shape features of the low-velocity zones from the data, such as boundary curvature, aspect ratio and area of the low-velocity zones. Specifically, a regional boundary can be captured by the image processing technology, such as edge detection algorithm (such as Canny edge detection), and then the regional shape can be quantified by shape descriptors (such as Hu moments). The gradient feature extraction focuses on a direction and an intensity of the wave velocity change in the low-velocity zones. For example, a gradient vector field in each zone is calculated to obtain a change trend of the wave velocity in space. The change feature extraction includes analyzing a time or space change pattern of the wave velocity, such as obtaining the change rates of the wave velocity through time series analysis or spatial filtering technology. These extracted features will form the regional shape data, the gradient data and the change data.

In step S252, geometric boundary smoothness for the regional shape data is calculated to obtain geometric boundary smoothness data.

In the embodiment, the geometric boundary smoothness for the regional shape data is calculated to reduce boundary noise and improve accuracy of feature extraction. In specific implementation, a smoothing algorithm, such as Gaussian filtering or median filtering, can be applied to smooth the geometric shape of the regional boundary. These algorithms eliminate noise by adjusting the curvature and shape of the boundary to ensure that the boundary is smoother. The smoothed boundary can be used to calculate boundary smoothness indicators, such as a root mean square error of the boundary curve or a smoothness ratio of the boundary. These indicators are used to evaluate the smoothness of the regional boundary and generate the geometric boundary smoothness data.

In step S253, gradient synthesis is performed on the gradient data and the change data to obtain gradient synthesis data.

In the embodiment, the gradient synthesis is to merge the gradient data obtained from different sources into a comprehensive gradient data set. In the specific implementation, firstly, the extracted gradient data is fused based on certain rules. For example, a weighted average method can be used, a weight of each gradient data source is set based on its importance in practical applications. Then, the fused gradient data is standardized to ensure that the gradient information of different data sources has consistent dimensions and distribution after synthesis. A goal of this process is to generate the gradient synthesis data that comprehensively reflects the wave velocity changes in the low-velocity zones.

In step S254, the geometric boundary smoothness data and the gradient synthesis data are integrated to obtain geometric gradient data.

In the embodiment, the geometric boundary smoothness data and the gradient synthesis data are integrated. The specific implementation method includes firstly performing feature matching and alignment on the geometric boundary smoothness data and the gradient synthesis data, and then integrating the two through a fusion algorithm (such as weighted sum or principal component analysis). The integration method can be adjusted based on the characteristics of the data. For example, the geometric gradient characteristics of each zone are determined through comprehensive analysis by combining the boundary smoothness and gradient synthesis data. The final result of this step is the geometric gradient data, which comprehensively considers the smoothness of the regional shape and the gradient information of the velocity change.

In step S255, the low-velocity recognition model is constructed based on the geometric gradient data.

In the embodiment, the low-velocity recognition model is constructed. Based on the geometric gradient data extracted above, the model is trained by a machine learning algorithm. Common methods include support vector machines (SVM), decision trees, or neural networks. The training image dataset includes labeled low-velocity regional samples and their corresponding geometric gradient data. During the model training process, the cross-validation technology is used to optimize the parameters of the low-velocity recognition model to ensure the generalization ability of the model. After the training is completed, the model can recognize and classify the low-velocity zones of the newly input data. Model evaluation can verify its performance through indicators such as accuracy and recall rate to ensure its effectiveness in practical applications.

In an embodiment, the step S252 specifically includes the following steps.

Boundary point coordinate data is extracted from the regional shape data.

In the embodiment, the boundary point coordinate data is extracted from the regional shape data. For example, in urban planning, a geographic information system (GIS) software is used to import vector layer data of a region, which is usually stored in a form of polygons. Boundary point coordinates of the region are exported through a boundary extraction tool of the software. These coordinate points will be arranged in order to form a point list, such as [(0,0), (0,10), (10,10), (10,0)]. It is ensured that all boundary points are extracted in the actual order of the boundary, so that the curve fitting and analysis in the subsequent processing are accurate.

Curve parameterization is performed on the boundary point coordinate data to obtain curve parameterized data.

In the embodiment, the curve parameterization is performed on the extracted boundary point coordinate data. An arc length parameterization method is selected, that is, parameter mapping is performed based on a distance between boundary points. A total distance from each boundary point to a starting point is calculated, and these distances are normalized to generate a parameter value sequence. For example, for a rectangular region, a length of each side is calculated, and a parameter value of each point is set to a total length accumulated along the boundary. This parameterization can convert a discrete set of points into a continuous curve for description, laying the foundation for subsequent curvature calculations.

Curvatures of boundary points are calculated based on the curve parameterized data to obtain boundary point curvature data.

In the embodiment, a curvature of each boundary point is calculated by using the curve parameterized data. An appropriate numerical method is selected to calculate the curvatures, such as using a second-order derivative of the curve. When the curve is discrete, the curvature can be estimated by using a difference method of adjacent points. For example, for a rectangle, a curvature of its corner points is usually very large, thus, the curvature calculation can be concentrated on the midpoint of the curve segment. In this way, a series of curvature values are obtained, which can reflect the changing characteristics of the boundary.

An average curvature of the boundary point curvature data is calculated to obtain average curvature data.

In the embodiment, the calculated curvature data is averaged to obtain the average curvature data. For example, the curvature values of all boundary points are summarized and their arithmetic mean is calculated. Assuming that the calculated curvature data includes {0.1, 0.2, 0.15, 0.25}, the average curvature is an average of these values. A purpose of this step is to provide an overall curvature feature to help understand the overall smoothness of the boundary.

A smoothness index is calculated based on the average curvature data to obtain the geometric boundary smoothness data.

In the embodiment, the smoothness index of the boundary is calculated based on the average curvature data. This index is used to measure the smoothness of the boundary, and is usually an inverse of the average curvature or some transformation thereof. For example, when the calculated average curvature is 0.2, the smoothness index can be 1/0.2=5. This smoothness index provides a quantitative indicator to evaluate the smoothness of the boundary, and the higher the value, the smoother the boundary. This result can be used to determine whether the regional design meets the expected geometric standards.

In an embodiment, the step S253 specifically includes the following steps.

Gradient amplitudes of the gradient data are calculated to obtain gradient amplitude data.

In the embodiment, gradient amplitude of the image data or terrain data are calculated.

Assuming that the operation is performed in a digital elevation model (DEM). The gradient amplitude of each pixel is calculated by using the image processing software or a GIS tool. The specific steps are to apply a gradient operator (such as a Sobel operator) to each pixel to calculate gradient components in a horizontal direction (x direction) and a vertical direction (y direction). Then, the gradient amplitude is calculated by using these gradient components, which is essentially a square root of a sum of squares of these two components. For example, for a pixel, a horizontal gradient is 3 and a vertical gradient is 4, then the gradient amplitude of the pixel is 5. This amplitude value provides an intensity of change of each point.

Change rates of the change data are calculated to obtain change rate data.

In the embodiment, the change rates of the change data are calculated. The change data comes from time series images, such as surface temperature data at different time points.

Calculating the change rates is to measure a speed of change over time. For example, when there are data at two time points, t1 and t2, and the corresponding values are V1 and V2, then the change rate is (V2-V1)/Δt, where Δt is a time interval. For the surface temperature data, assuming that a temperature of a certain place is 15 Celsius degrees (° C.) at t1 and 18° C. at t2, and the time interval is 1 year, then the change rate is 3° C./year. This step is used to measure the speed at which data changes over time.

Spatial alignment is performed on the change rate data and the gradient amplitude data to obtain change spatial alignment data.

In the embodiment, the spatial alignment is performed on the change rate data and the gradient amplitude data. Assuming that the gradient amplitude data and the change rate data originate from different sensors or datasets, they need to be spatially aligned, so that they can be analyzed in a same coordinate system. Specifically, an image registration technology is used to align the two datasets through affine transformation or other spatial transformation. For example, between satellite images and ground sensor data, feature matching methods (such as scale-invariant feature transform abbreviated as SIFT) are used to align data points to ensure that the gradient amplitude of each point matches the corresponding change rate. This step ensures that subsequent weighted synthesis can be processed at a same spatial position.

Weight synthesis is performed on the change spatial alignment data and the gradient amplitude data to obtain the gradient synthesis data.

In the embodiment, the weight synthesis is performed on the change spatial alignment data and the gradient amplitude data to obtain the gradient synthesis data. A suitable weighting method is selected to combine the gradient amplitude data and the change spatial alignment data. For example, the gradient amplitude can be used as a weight to weight the change rate data, that is, the change rate of each point is multiplied by its corresponding gradient amplitude, and then normalized to obtain a weighted synthetic value. For example, when the gradient amplitude of a certain region is 5, and the change rate is 3° C./year, the weighted synthetic value of the region is 15. This synthetic data can be used for further analysis, such as recognizing key regions of surface change or evaluating the impact of terrain on change.

In an embodiment, the step S3 specifically includes the following steps S31 to S37.

In step S31, the seismic first arrival prediction model is constructed based on the functionally concentrated and enhanced grayscale image set.

In the embodiment, firstly, a representative seismic grayscale image set is collected and integrated, which should cover different seismic events and geological backgrounds. Then, these grayscale images are preprocessed by using the image enhancement technologies (such as histogram equalization and Gaussian filtering) to improve the contrast and clarity of the images. Next, the deep learning model (such as a convolutional neural network) is used to train a seismic first arrival prediction model, which will learn the characteristics of seismic wave propagation from the enhanced images, thereby accurately predicting the seismic first arrival times and locations.

In step S32, seismic first arrival time data and seismic first arrival location data are extracted from the corrected training image set.

In the embodiment, the corrected training image set is analyzed to extract the seismic first arrival time data and the seismic first arrival location data. These data should include actual recorded seismic first arrival times and the corresponding seismic wave positions. The extraction method can be through image recognition technology or manual annotation to ensure that the obtained data set has high accuracy and representativeness.

In step S33, a probability distribution of first arrival times is calculated based on the seismic first arrival time data to obtain seismic first arrival time probability data.

In the embodiment, the probability distribution of the first arrival times is calculated based on the seismic first arrival time data. This process involves statistical analysis of historical seismic data to determine the probability distribution of the first arrival times of different seismic events. A probability model (such as a Bayesian model) is constructed to describe the changing trend of these times, thereby obtaining the probability data of the seismic first arrival times.

In step S34, first arrival extent statistics is performed based on the seismic first arrival location data to obtain seismic first arrival extent data.

In the embodiment, the first arrival extent statistics is performed based on the seismic first arrival location data. The first arrival location data of different seismic events is analyzed to calculate a spatial distribution extent of the first arrival waves. The statistical method may include calculating a mean, a standard deviation and spatial distribution characteristics of the location data to obtain the seismic first arrival geographical extent data.

In step S35, the seismic first arrival time probability data and the seismic first arrival extent data are integrated to obtain seismic first arrival data.

In the embodiment, the seismic first arrival time probability data and the seismic first arrival extent data are integrated. This process involves combining the time probability distribution with the spatial extent data to construct a comprehensive seismic first arrival dataset. This dataset will help understand the seismic first arrival time and spatial distribution characteristics and provide more comprehensive information for the prediction model.

In step S36, the seismic first arrival prediction model is trained based on the seismic first arrival data to obtain the seismic first arrival training model.

In the embodiment, the integrated seismic first arrival data is used to train the initially constructed seismic first arrival prediction model. The integrated dataset (i.e., the seismic first arrival data) is used as a training sample, parameters of the seismic first arrival prediction model are optimized through the training process to improve the accuracy and robustness of the model. An ultimate goal of this step is to obtain a trained seismic first arrival prediction model that can predict the seismic first arrival times and locations based on the input image data.

In step S37, the parameters of the seismic first arrival training model are optimized based on the corrected training image set to obtain the optimized seismic first arrival training model.

In the embodiment, the seismic first arrival training model is optimized. The data in the corrected training image set is used to adjust parameters in the model, to improve the prediction accuracy of the model. The optimization method includes adjusting hyperparameters such as learning rate, batch size, and number of training rounds to ensure that the model has the optimal performance in practical applications. The optimized seismic first arrival training model finally obtained should have high prediction accuracy and reliability.

In an embodiment, the step S4 specifically includes the following steps S41 to S46.

In step S41, the seismic first arrival prediction is performed on the testing image set by using the optimized seismic first arrival training model to obtain the seismic first arrival prediction data.

In the embodiment, the optimized seismic first arrival training model is used to predict the testing image set. The testing image set comes from a seismic observation system, and is pre-processed to ensure the quality and consistency of data. The optimized seismic first arrival training model is usually a deep learning model trained based on historical seismic data, which can recognize and predict the first arrival times of the seismic waves. The optimization of the model includes adjusting the network structure, training parameters, and adding the latest seismic wave feature data. The predicted result is the seismic first arrival predicted time in each test image, and the predicted data will be used for subsequent evaluation and analysis.

In step S42, the seismic first arrival prediction data is classified based on the image sizes to obtain the fixed-size image prediction data and the arbitrary-size image prediction data.

In the embodiment, the seismic first arrival prediction data is classified based on the image sizes. Specifically, the prediction data is classified to the fixed-size image prediction data and the arbitrary-size image prediction data based on the image sizes. The fixed-size image prediction data refers to images of fixed-size (for example, 512×512 pixels) specified during training, and these images remain unchanged in size during the prediction process. The arbitrary-size image prediction data includes images whose specific size is not specified during the training process, and the size may change. During the classification process, the image size needs to be detected and recorded, so that targeted accuracy calculations can be performed in subsequent steps.

In step S43, a fixed-size image prediction accuracy of the fixed-size image prediction data is calculated based on the corrected training image set to obtain fixed-size image prediction accuracy data.

In the embodiment, the accuracy of the fixed-size image prediction data is calculated.

Firstly, the corrected training image set (i.e., the seismic image dataset after manual annotation or correction) is used as a reference to compare a difference between the first arrival times predicted by the model and the actual first arrival times. The calculation of the accuracy includes calculating statistical indicators such as an error and a standard deviation of the predicted times to evaluate the performance of the model on the fixed-size image. The accuracy is usually expressed as the relative difference between the predicted values and the actual values, which provides the reliability of the model prediction on the fixed-size image data.

In step S44, an arbitrary-size image prediction accuracy of the arbitrary-size image prediction data is calculated based on the corrected training image set to obtain arbitrary-size image prediction accuracy data.

In the embodiment, the accuracy of the arbitrary-size image prediction data is calculated. The arbitrary-size image prediction data in the corrected training image set is used for comparison to evaluate the performance of the model on images of different sizes. The calculation method is similar to that of fixed-size images, including error calculation and statistical analysis. Since arbitrary-size images have more variability, preprocessing operations such as image scaling or cropping are required to ensure consistency in the comparison of prediction results.

In step S45, the fixed-size image prediction accuracy data and the arbitrary-size image prediction accuracy data are integrated to obtain seismic first arrival prediction accuracy data.

In the embodiment, the accuracy data is integrated. The specific method includes summarizing the fixed-size image prediction accuracy data and the arbitrary-size image prediction accuracy data, and obtaining the overall seismic first arrival prediction accuracy data through weighted average or other statistical methods. The purpose of the integration is to provide a comprehensive evaluation to reflect the overall performance of the model on different types of images. This step involves calculating indicators such as the overall prediction accuracy and error range to provide an evaluation of the overall performance of the model.

In step S46, the prediction result of the seismic first arrival prediction accuracy data is evaluated to obtain the prediction result evaluation data, and the prediction result evaluation data is uploaded to the seismic shot platform processing system to execute the seismic first arrival prediction task.

In the embodiment, the prediction result of the integrated seismic first arrival prediction accuracy data is evaluated. This includes analyzing the reliability of the prediction result, and the performance of the model in practical applications. The evaluation data can be presented in a form of statistical reports, charts, and the like. After the evaluation is completed, the prediction result is uploaded to the seismic shot platform processing system, which will further analyze the data and apply it to the actual seismic prediction task. The upload process needs to ensure the integrity and accuracy of the data, usually including steps such as data formatting and verification, for subsequent processing and analysis.

In an embodiment, the step S43 specifically includes the following steps S431 to S434.

In step S431, fixed-size seismic first arrival prediction data is extracted from the fixed-size image prediction data.

In the embodiment, the CNN is used to analyze the seismic data. The spatial distribution characteristics of the seismic data are considered, the input seismic data images are first cropped or scaled to a uniform fixed size (e.g., 256×256 pixels). The seismic first arrival prediction is performed by a pre-trained deep learning model to output a predicted image, which contains the first arrival prediction value corresponding to each pixel. In order to ensure the uniformity and comparability of the data, the resolution and size of the predicted data must be consistent with the training data.

In step S432, seismic first arrival corrected data is extracted from the corrected raining image set.

In the embodiment, seismic first arrival actual observation data (i.e., the seismic first arrival corrected data) is extracted from the corrected raining image set. Firstly, each image in the corrected raining image set is cropped or scaled to a fixed size the same as the predicted data. For example, for each correction image, the seismic first arrival actual arrival time is determined and labeled as the first arrival corrected data. The corrected data should be strictly aligned with the predicted data in space to ensure that the labeled data of each pixel accurately reflects the real seismic first arrival information.

In step S433, seismic first arrival annotation comparison is performed on the fixed-size seismic first arrival prediction data according to the seismic first arrival corrected data to obtain fixed-size image seismic first arrival annotation comparison data.

In the embodiment, the fixed-size seismic first arrival prediction data is compared with the seismic first arrival corrected data. A pixel-level comparison method is used to match each predicted value with the corresponding corrected data to recognize the difference between the prediction and the actual annotation. Through comparative analysis, the fixed-size image seismic first arrival annotation comparison data is generated. This dataset shows an error distribution of each predicted point and the actual corrected point, which helps to further evaluate and improve the prediction model.

In step S434, accuracy calculation is performed on the fixed-size image seismic first arrival annotation comparison data based on the corrected training image set to obtain the fixed-size image prediction accuracy data.

In the embodiment, the accuracy of the prediction is calculated based on the seismic first arrival annotation comparison data. The accuracy is defined as a ratio of correctly predicted pixels in the prediction data to the total predicted pixels. The matching of the accurately annotated prediction points and the actual value points in the data is compared, and a ratio between a number of the correctly predicted pixels and the total number of predicted pixels is counted. The prediction accuracy data of the fixed-size image is obtained, which reflects the prediction ability of the model under fixed-size. In order to improve the calculation accuracy, different types of error analysis can be considered, such as error distribution and deviation measurement.

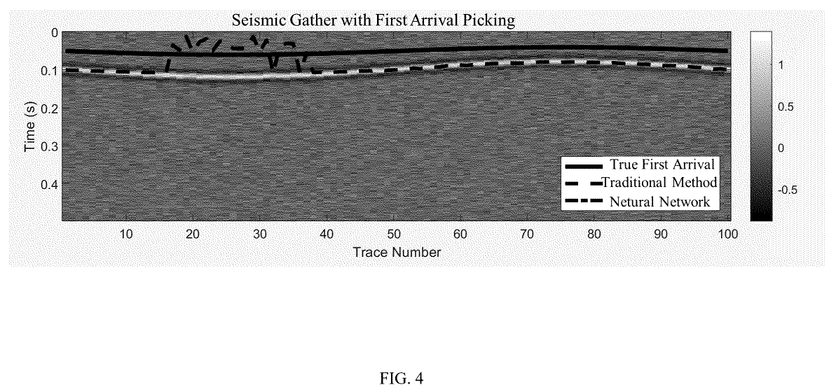

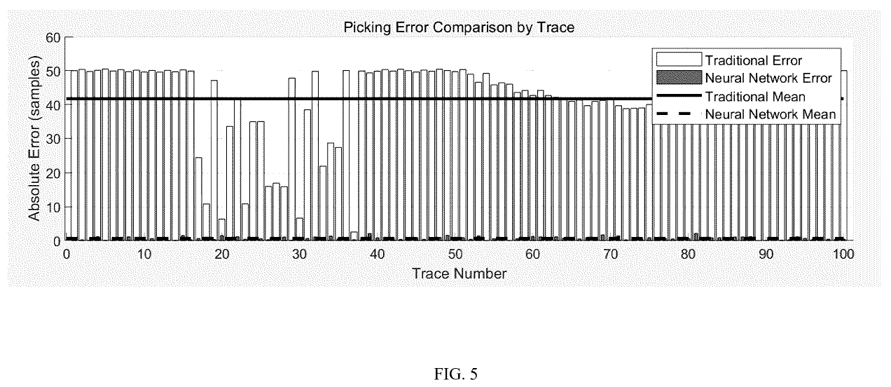

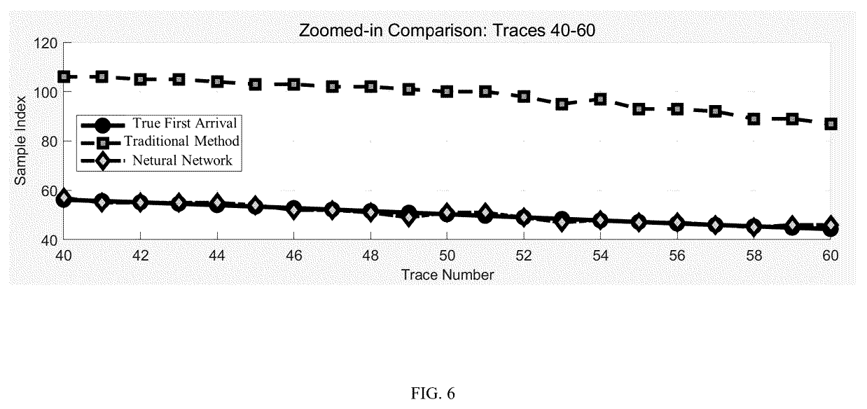

FIGS. 4-6 illustrate schematic diagrams of performance differences between a traditional method for first arrival picking in seismic data and the SimpleNet-based method for first arrival picking in seismic data of the disclosure. It can be seen that the accuracy of seismic first-arrival picking is substantially improved through the SimpleNet-based method for first arrival picking in seismic data of the disclosure. Compared to the traditional method, the proposed SimpleNet-based method achieves an 89% reduction in mean picking error, and reducing deviation from 7.2±2.8 (i.e., 4.4 to 10.0) samples to merely 0.8±0.3 (i.e., 0.5 to 1.1) samples. Visual comparison across all traces confirms near-perfect alignment between the neural network-picked first arrivals and ground truth values. In contrast, traditional method exhibits significant deviations, particularly within geologically complex zones (e.g., traces 20-40 and 70-90). Error distribution analysis further establishes the superiority of the SimpleNet-based method: 92% of its predictions fall within ±1 sample error, compared to only 34% for the traditional method. Cumulative error progression reinforces this advantage, with the neural network (i.e., SimpleNet-based method) maintaining high precision across 87% of traces before reaching the 50% error saturation threshold—more than double the 42% achieved by traditional method. This advancement facilitates fully automated processing of low-quality field data without requiring manual parameter tuning. By leveraging holistic waveform context rather than localized signal characteristics, the deep learning model introduces a new paradigm for first arrival picking—dramatically reducing interpretive uncertainty in complex geology and accelerating processing workflows by 3-5 times. The 89% improvement in accuracy validates the use of neural networks as a new standard for high-fidelity seismic interpretation, offering significant gains in error reduction, geological adaptability, noise robustness, and operational efficiency—all supported by extensive experimental evidence.

Therefore, the embodiments should be regarded as illustrative and non-restrictive from all points, and the scope of the disclosure is limited by the appended claims rather than the above description, and it is therefore intended that all changes falling within a meaning and a range of equivalent elements of the application documents are included in the disclosure.

The above description is merely a specific embodiment of the disclosure, so that those skilled in the art can understand or implement the disclosure. Various modifications to these embodiments will be apparent to those skilled in the art, and general principles defined herein may be implemented in other embodiments without departing from a spirit or a scope of the disclosure. Therefore, the disclosure will not be limited to the embodiments shown herein, but should conform to the widest scope consistent with principles and novel features invented herein.

What is claimed is:

1. A SimpleNet-based method for first arrival picking in seismic data, comprising:
step S1, obtaining seismic shot gather data, and converting the seismic shot gather data into grayscale images to thereby obtain a functionally concentrated and enhanced grayscale image set; wherein the step S1 specifically comprises:
step S11, obtaining the seismic shot gather data, and performing data-to-image mapping on the seismic shot gather data to obtain seismic shot gather grayscale images;
step S12, performing first arrival function salient labeling on the seismic shot gather grayscale images to obtain salient grayscale images;
step S13, performing first arrival function distribution label cropping on the salient grayscale images to obtain concentrated grayscale images; and
step S14, performing data enhancement on the concentrated grayscale images to obtain the functionally concentrated and enhanced grayscale image set;
step S2, classifying the functionally concentrated and enhanced grayscale image set to obtain a training image set and a testing image set, and performing low-velocity zone static correction on the training image set to obtain a corrected training image set; wherein the step S2 specifically comprises:
step S21, classifying the functionally concentrated and enhanced grayscale image set to obtain the training image set and the testing image set;
step S22, plotting velocity profile distribution maps according to the training image set;
step S23, performing velocity statistics on the velocity profile distribution maps to obtain low-velocity data;
step S24, performing, based on the low-velocity data, regional positioning on the velocity profile distribution maps to obtain low-velocity regional data;
step S25, constructing, based on the low-velocity regional data, a low-velocity recognition model; wherein the step S25 specifically comprises:
step S251, performing regional shape feature extraction, gradient feature extraction and change feature extraction on the low-velocity regional data to obtain regional shape data, gradient data and change data;
step S252, calculating geometric boundary smoothness for the regional shape data to obtain geometric boundary smoothness data;
step S253, performing gradient synthesis on the gradient data and the change data to obtain gradient synthesis data;
step S254, integrating the geometric boundary smoothness data and the gradient synthesis data to obtain geometric gradient data; and
step S255, constructing, based on the geometric gradient data, the low-velocity recognition model;
step S26, performing, based on the low-velocity recognition model, low-velocity recognition on the training image set to obtain a low-velocity training image set; and
step S27, performing, based on the low-velocity training image set, low-velocity correction on the training image set to obtain the corrected training image set;
step S3, constructing, based on the functionally concentrated and enhanced grayscale image set, a seismic first arrival prediction model; training, based on the corrected training image set, the seismic first arrival prediction model to obtain a seismic first arrival training model; and optimizing parameters of the seismic first arrival training model to obtain an optimized seismic first arrival training model; and
step S4, performing, by using the optimized seismic first arrival training model, seismic first arrival prediction on the testing image set to obtain seismic first arrival prediction data; classifying, based on image sizes, the seismic first arrival prediction data to obtain fixed-size image prediction data and arbitrary-size image prediction data; and evaluating prediction results of the fixed-size image prediction data and the arbitrary-size image prediction data to obtain prediction result evaluation data, and uploading the prediction result evaluation data to a seismic shot platform processing system to execute a seismic first arrival prediction task.

2. The SimpleNet-based method for first arrival picking in seismic data as claimed in claim 1, wherein the step S14 specifically comprises:
step S141, extracting grayscale image samples from the concentrated grayscale images to obtain concentrated grayscale image sample data;
step S142, performing a horizontal mirror transformation on the concentrated grayscale image sample data to obtain concentrated grayscale mirror data;
step S143, replacing image data in the concentrated grayscale images with the concentrated grayscale mirror data to obtain concentrated grayscale image replacement data; and
step S144, performing image enhancement integration on the concentrated grayscale image replacement data and the concentrated grayscale images to obtain the functionally concentrated and enhanced grayscale image set.

3. The SimpleNet-based method for first arrival picking in seismic data as claimed in claim 1, wherein the step S252 specifically comprises:
extracting boundary point coordinate data from the regional shape data;
performing curve parameterization on the boundary point coordinate data to obtain curve parameterized data;
calculating, based on the curve parameterized data, curvatures of boundary points to obtain boundary point curvature data;
calculating an average curvature of the boundary point curvature data to obtain average curvature data; and
calculating, based on the average curvature data, a smoothness index to obtain the geometric boundary smoothness data.

4. The SimpleNet-based method for first arrival picking in seismic data as claimed in claim 1, wherein the step S253 specifically comprises:
calculating gradient amplitudes for the gradient data to obtain gradient amplitude data;
calculating change rates of the change data to obtain change rate data;
performing spatial alignment on the gradient amplitude data and the change rate data to obtain change spatial alignment data; and
performing weight synthesis on the change spatial alignment data and the gradient amplitude data to obtain the gradient synthesis data.

5. The SimpleNet-based method for first arrival picking in seismic data as claimed in claim 1, wherein the step S3 specifically comprises:
step S31, constructing the seismic first arrival prediction model based on the functionally concentrated and enhanced grayscale image set;
step S32, extracting seismic first arrival time data and seismic first arrival location data from the corrected training image set;
step S33, calculating, based on the seismic first arrival time data, a probability distribution of first arrival times to obtain seismic first arrival time probability data;
step S34, performing first arrival extent statistics on the seismic first arrival location data to obtain seismic first arrival extent data;
step S35, integrating the seismic first arrival time probability data and the seismic first arrival extent data to obtain seismic first arrival data;
step S36, training, based on the seismic first arrival data, the seismic first arrival prediction model to obtain the seismic first arrival training model; and
step S37, optimizing, based on the corrected training image set, the parameters of the seismic first arrival training model to obtain the optimized seismic first arrival training model.

6. The SimpleNet-based method for first arrival picking in seismic data as claimed in claim 1, wherein the step S4 specifically comprises:
step S41, performing, by using the optimized seismic first arrival training model, the seismic first arrival prediction on the testing image set to obtain the seismic first arrival prediction data;
step S42, classifying, based on the image sizes, the seismic first arrival prediction data to obtain the fixed-size image prediction data and the arbitrary-size image prediction data;
step S43, calculating, based on the corrected training image set, a fixed-size image prediction accuracy of the fixed-size image prediction data to obtain fixed-size image prediction accuracy data;
step S44, calculating, based on the corrected training image set, an arbitrary-size image prediction accuracy of the arbitrary-size image prediction data to obtain arbitrary-size image prediction accuracy data;
step S45, integrating the fixed-size image prediction accuracy data and the arbitrary-size image prediction accuracy data to obtain seismic first arrival prediction accuracy data; and
step S46, evaluating a prediction result of the seismic first arrival prediction accuracy data to obtain the prediction result evaluation data, and uploading the prediction result evaluation data to the seismic shot platform processing system to execute the seismic first arrival prediction task.

7. The SimpleNet-based method for first arrival picking in seismic data as claimed in claim 6, wherein the step S43 specifically comprises:
step S431, extracting fixed-size seismic first arrival prediction data from the fixed-size image prediction data;
step S432, extracting seismic first arrival corrected data from the corrected raining image set;
step S433, performing, based on the seismic first arrival corrected data, seismic first arrival annotation comparison on the fixed-size seismic first arrival prediction data to obtain fixed-size image seismic first arrival annotation comparison data; and
step S434, performing, based on the corrected training image set, accuracy calculation on the fixed-size image seismic first arrival annotation comparison data to obtain the fixed-size image prediction accuracy data.
